(19) United States
(12) Patent Application Publication
(10) Pub. No.: US 2007/0080593 A1
(43) Pub. Date: Apr. 12, 2007

(54) Bearing sleeve

(76) Inventor: Steven B. O'Donnell, Seal Beach, CA (US)

Correspondence Address: AVERILL & VARN, 8244 PAINTER AVE., WHITTIER, CA, 90602, US

(21) Appl. No.: 11/246,047

(22) Filed: Oct. 7, 2005

(51) Int. Cl. H02K 5/24; H02K 5/16

(52) U.S. Cl. 310/90; 384/215; 310/51

(57) ABSTRACT

A compliant bearing sleeve resides between a bearing and a bearing seat, thus opening tolerance requirements, and providing thermal and mechanical insulation of the bearing from the bearing seat. The bearing sleeve comprises alternating outside and inside ribs residing on a sleeve body. In a relaxed state (i.e., not inserted into a motor) the sleeve body is cylindrical. When the bearing sleeve is inserted into the motor, the ribs cause the sleeve body to deform to allow the sleeve to fit between the bearing seat and the bearing. The bearing sleeve preferably includes an axial bearing stop to retain the bearing, and is preferably made of a high temperature material.

### BACKGROUND OF THE INVENTION

The present invention relates to a sleeve for supporting a bearing and in particular to a sleeve providing thermal and mechanical insulation, and opening tolerance requirements, for a bearing.

Electric motors generally include bearings to allow low friction rotation of a motor armature. In high performance motors, ball, needle, or roller bearings are often used to minimize rotating friction. The fits between the bearing and the motor case or endbell often have very close tolerances. In the instance of a motor with an anodized endbell, the close tolerances are complicated by effects of anodizing. The variation in tolerances after anodizing often reduce production yield.

U.S. Pat. No. 6,749,342 for “Bearing System, Especially for Yarn Feed Device,” describes a squeeze element 36 residing between an outer bearing race and a bearing seat 21. In a preferred embodiment, the squeeze element 36 is a smooth cylinder and the bearing seat 21 includes inward facing the ribs 26 which cause the squeeze element 36 to deform (see FIGS. 3-5). In another embodiment, the squeeze element comprises a body 36a and squeeze regions 36b spaced angularly apart at equal intervals along the body 36a (see FIGS. 6 and 7 of the '342 patent). The squeeze element is described as being made from a polymer, but no further details are provided. Unfortunately, the squeeze regions 36b are likely to be scraped, and thus damaged, when the squeeze element in inserted into an endbell. Further, the squeeze element is open at both ends, requiring the bearing to seat axially against the endbell, thus allowing the transfer of both heat and vibrations directly from the endbell to the bearing.

### BRIEF SUMMARY OF THE INVENTION

The present invention addresses the above and other needs by providing a compliant bearing sleeve which resides between a bearing and a bearing seat, thus opening tolerance requirements, and providing thermal and mechanical insulation of the bearing from the bearing seat. The bearing sleeve comprises alternating outside and inside ribs residing on a sleeve body. In a relaxed state (i.e., not inserted into a motor) the sleeve body is cylindrical. When the bearing sleeve is inserted into the motor, the ribs cause the sleeve body to deform to allow the sleeve to fit between the bearing seat and the bearing. The bearing sleeve preferably includes an axial bearing stop to retain the bearing and is preferably made of a material resistance to high temperature.

In accordance with one aspect of the invention, there is provided an electric motor having an armature with an armature shaft, a case enclosing the armature, an endbell at an open end of the case, a bearing seat in the endbell, a bearing between the endbell and the armature shaft, and a bearing sleeve between the bearing and the bearing seat. The bearing sleeve comprises a deformable cylindrical sleeve body having an outside surface and an inside surface, outside ribs angularly spaced apart on the outside surface, and inside ribs angularly spaced apart on the inside surface and in angular gaps between the outside ribs. The sleeve body is deformed when in an assembled motor by the inward biasing of the outside ribs by the bearing seat and the outward biasing of the inside ribs by the bearing, and a resistance to deformation of the sleeve body providing a firm fit for the bearing into the bearing seat. The bearing sleeve preferably is made from a polymer resistance to high temperature, and preferably includes an axial bearing stop to prevent direct axial contact of the bearing with the bearing seat. The number of insides ribs is preferably equal to the number of outside ribs.

In accordance with another aspect of the invention, there is provided a bearing sleeve comprising a deformable cylindrical sleeve body having an outside surface and an inside surface, outside ribs angularly spaced apart on the outside surface, and inside ribs angularly spaced apart on the inside surface and angularly spaced between the outside ribs. The sleeve body is deformed when residing between a bearing and a bearing seat by the inward biasing of the outside ribs by the bearing seat and the outward biasing of the inside ribs by the bearing, a resistance to deformation of the sleeve body providing a firm fit for the bearing into the bearing seat. The bearing sleeve may support bearings in a variety of applications including electric motors, axles, transmissions, and any application including bearings.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is an exploded view of an electric motor including a bearing sleeve according to the present invention.

FIG. 2 is a detailed perspective view of the bearing sleeve.

FIG. 3 is a side view of the bearing sleeve.

FIG. 4A is a cross-sectional view of the bearing sleeve taken along line 4A-4A of FIG. 3.

FIG. 4B is a cross-sectional view of the bearing sleeve taken along line 4B-4B of FIG. 3.

FIG. 4C is a cross-sectional view of the bearing sleeve taken along line 4C-4C of FIG. 3.

FIG. 5 depicts the deformation of a sleeve body of the bearing sleeve when the bearing sleeve resides between a bearing and a bearing seat.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

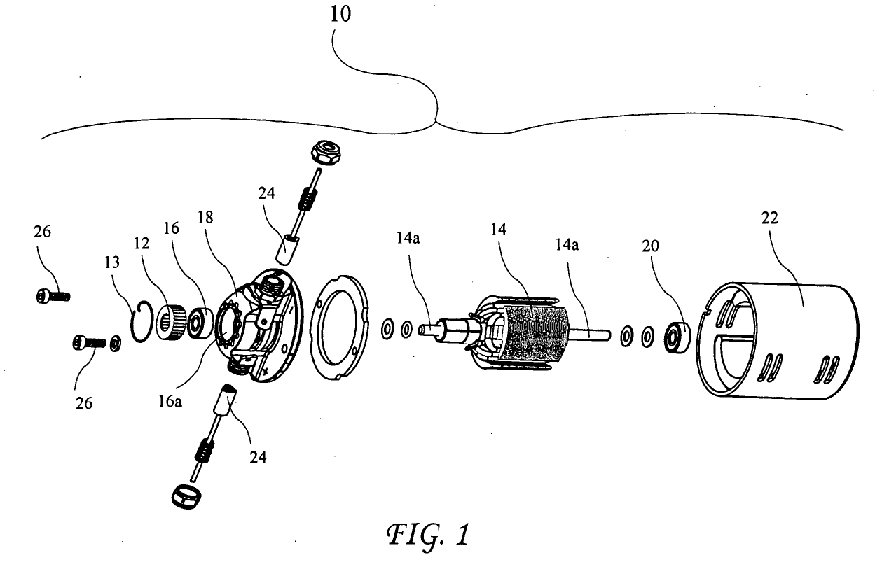

An exploded view of an electric motor 10 including a bearing sleeve 12 according to the present invention is shown in FIG. 1. The motor 10 further includes an armature 14 having an armature shaft 14a. The armature shaft 14a is supported in an endbell 18 by an endbell bearing 16, and in a motor case 22 by a case bearing 20. Brushes 24 reside in the endbell 14, and endbell screws 26 attach the endbell 18 to the case 22. The bearing sleeve 12 is retained in a bearing seat 16a in the endbell 18 by a clip 13. Although the invention is shown in a brush type motor, the present invention applies equally to a brushless motor, and a brushless motor including a bearing sleeve as described herein is intended to come within the scope of the present invention.

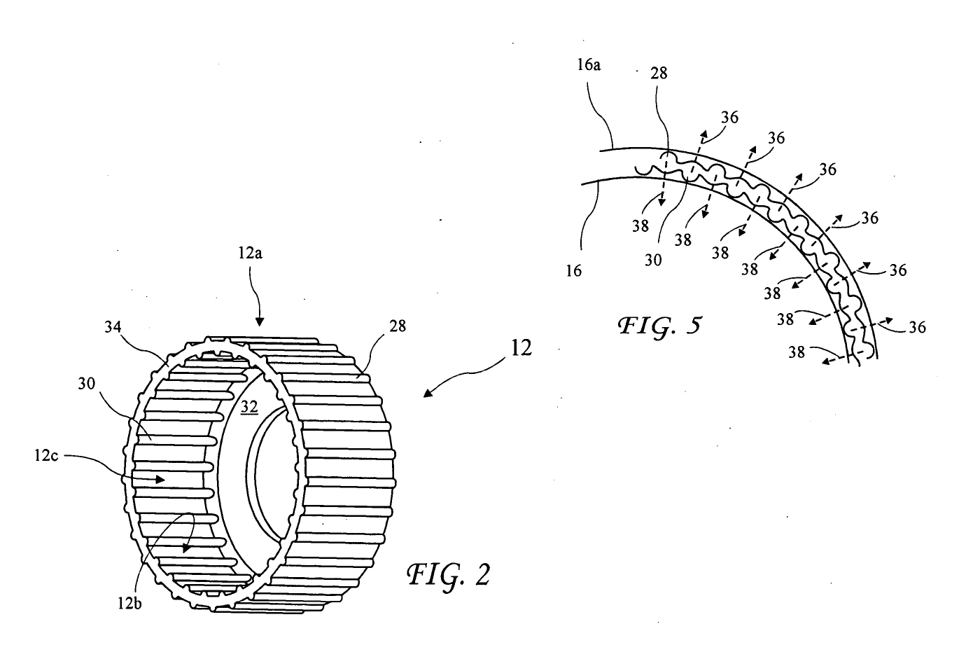

A detailed perspective view of the bearing sleeve 12 is shown in FIG. 2. The bearing sleeve 12 includes an outside surface 12a and an inside surface 12b. Angularly spaced apart axially running outside ribs 28 reside on the outside surface 12a, and angularly spaced apart axially running inside ribs 30 reside on the inside surface 12b. The bearing sleeve 12 interior defines a bearing sleeve cavity 12c wherein the bearing 16 resides in an assembled motor 10.

The outside ribs 28 preferably are uniformly angularly spaced apart, and preferably run substantially the length (see FIG. 4B) of the bearing sleeve 12. While the outside ribs 28 do not necessarily run the entire length of the bearing sleeve 12, they preferably run a sufficient length to prevent the bearing sleeve 12 from wobbling in the bearing seat 16a. The inside ribs 30 preferably are uniformly angularly spaces apart, and preferably run substantially the length (see FIG. 4B) of the bearing sleeve cavity 12c. While the inside ribs 28 do not necessarily run the entire length of the bearing sleeve cavity 12c, the inside ribs 28 preferably run a sufficient length to prevent the bearing 16 from wobbling in the bearing sleeve cavity 12c. The inside ribs 30 are preferably angularly spaced approximately half way between pairs of the outside ribs 28, and the number of inside ribs 30 is preferably equal to the number of outside ribs 28.

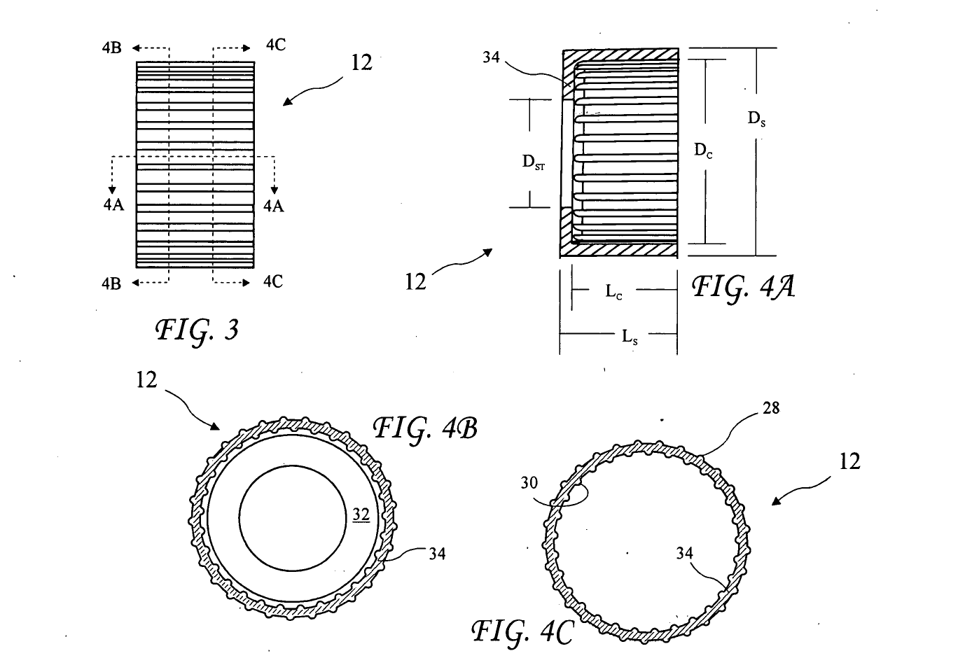

A side view of the bearing sleeve 12 is shown in FIG. 3 and a cross-sectional view of the bearing sleeve 12 taken along line 4A-4A of FIG. 3 is shown in FIG. 4A. The bearing sleeve 12 has a sleeve length L_{S} and a sleeve diameter D_{S}. The length L_{S} is preferably approximately 0.172 inches and the diameter D_{S} is preferably approximately 0.423 inches not including the outside ribs 28, and is approximately 0.438 inches including the outside ribs 28. The outside ribs 28 are substantially semi circular in shape with a radius of preferably approximately 0.0075 inches.

The sleeve cavity 12c cavity length L_{C} and a cavity diameter D_{C}. The cavity length L_{C} is preferably approximately 0.155 inches and the cavity diameter D_{C} is preferably approximately 0.389 inches not including the inside ribs 30, and the diameter including the inside ribs 30 is approximately 0.374 inches. The inside ribs 30 are substantially semi circular in shape with a radius of preferably approximately 0.0075 inches. The sleeve body 34 is preferably approximately 0.034 inches thick. The inside diameter D_{ST} of the stop 32 is preferably approximately 0.225 inches. The dimensions of the bearing sleeve 12 are for a particular bearing and endbell. The stop 32 preferably extends inwardly to an inner bearing race, and preferably substantially covers the exposed portion of the bearing only leaving the inner bearing race exposed, but preferably does touch the inner bearing race. In low RPM applications the stop may contact the inner bearing race to provide free seal.

The bearing sleeve 12 dimensions may vary for different bearings, endbells, and fit requirements, and any bearing sleeve having spaced apart exterior ribs, and spaced apart interior ribs residing angularly offset from the exterior ribs, is intended to come within the scope of the present invention.

A cross-sectional view of the bearing sleeve taken along line 4B-4B of FIG. 3 is shown in FIG. 4B, and cross-sectional view of the bearing sleeve 12 taken along line 4C-4C of FIG. 3 is shown in FIG. 4C. The inside ribs 28 are seen to be angularly spaced between the outside ribs 28. The bearing stop 32 partially encloses one end of the bearing sleeve 12. The outside ribs 28 preferably comprise 29 outside ribs and the inside ribs 30 preferably comprise 29 inside ribs. The numbers of outside ribs 28 is preferably the same as the number of inside ribs 30, with the inside ribs 30 residing centered between each adjacent pair of outside ribs.

The deformation of the sleeve body 34 of the bearing sleeve 12, when the bearing sleeve 12 resides between the bearing 16 and the bearing seat 16a of an assembled motor 12 is shown in FIG. 5. The outside ribs 28 are biased inwardly along arrows 38 by the bearing seat 16a and the inside ribs 30 are biased outwardly along arrows 36 by the bearing 16. As a result of the biasing, the sleeve body 34 is deformed. The resistance of the sleeve body 34 to the deforming provides a firm fit of the sleeve 12 into the bearing seat 16a, and of the bearing 16 into the sleeve cavity 12c.

The firmness of the fit between the bearing, the bearing sleeve, and the bearing seat is limited to prevent crush of an outer race of the bearing. Such fit may be controlled, for example, by the thickness of the sleeve body 34, and/or the number of outer ribs 28 and/or the inner ribs 30. For example, the number of inner ribs 30 may be one half the number of outer ribs 28, wherein the inner ribs 30 may be spaced between alternate pairs of outer ribs 28. The resistance to crush of the outer bearing race is generally provided as part of the bearing specification. A particular bearing sleeve design may be analyzed using one of the commonly available structural analysis programs such as Cosmos® advanced professional non-linear structural analysis tools from Structural Research & Analysis Corporation in Santa Monica, Calif. working with SolidWorks® software from SolidWorks Corporation in Concord Mass. The bearing sleeve may thus be designed to provide a sufficiently firm fit to hold the bearing without exceeding crush tolerance of the bearing. The design may further be evaluated over a range of bearing seat inside diameters to ensure that manufacturing tolerances for the bearing seat are acceptable.

The bearing sleeve 12 is preferably made from a high temperature polymer, and more preferably from a glass fiber reinforced lubed nylon, and most preferably from Zytel® 70G33 available from E. I. duPont de Nemours & Co. Wilmington, Del., or any material with similar mechanical properties. The ribs 28 and/or 30 may be square, oval, and may be segmented or continuous as depicted herein.

While the invention herein disclosed has been described by means of specific embodiments and applications thereof, numerous modifications and variations could be made thereto by those skilled in the art without departing from the scope of the invention set forth in the claims.

I claim:

1. An electric motor having an armature, a case enclosing the armature, an endbell at an open end of the case, a bearing seat in the endbell, and a bearing between the bearing seat and the armature, the improvement being a bearing sleeve residing between the bearing and the bearing seat, the bearing sleeve comprising:
a deformable cylindrical sleeve body having an outside surface and an inside surface;
axially running outside ribs angularly spaced apart on the outside surface; and
axially running inside ribs angularly spaced apart on the inside surface and residing in angular gaps between pairs of the outside ribs,
wherein the sleeve body is deformed when in an assembled motor by an inward biasing of the outside ribs by the bearing seat and an outward biasing of the inside ribs by the bearing, wherein a resistance to deformation of the sleeve body provides a firm fit for the bearing into the bearing seat.

2. The motor of claim 1, wherein the bearing sleeve includes an axial bearing stop attached to the sleeve body to retain the bearing.

3. The motor of claim 1, wherein the bearing sleeve is made from a polymer which is resistant to high temperature.

4. The motor of claim 3, wherein the bearing sleeve is made from a glass fiber reinforced lubed nylon.

5. The motor of claim 4, wherein the bearing sleeve is made from Zytel® 70G33 polymer.

6. The motor of claim 1, wherein the outside ribs are uniformly angularly spaced apart on the outside surface and the inside ribs are uniformly angularly spaced apart on the inside surface.

7. The motor of claim 6, wherein the inside ribs reside approximately evenly angularly centered between pairs of the outside ribs.

8. The motor of claim 1, wherein outside ribs have a substantially round profile.

9. The motor of claim 1, wherein inside ribs have a substantially round profile.

10. The motor of claim 1, wherein the outside ribs and the inside ribs axially run substantially all of the length of the bearing sleeve.

11. A bearing sleeve comprising:
a deformable cylindrical sleeve body having an outside surface and an inside surface;
outside ribs angularly spaced apart on the outside surface; and
inside ribs angularly spaced apart on the inside surface and angularly spaced between pairs of the outside ribs,
wherein the sleeve body is deformed when residing between a bearing and a bearing seat by an inward biasing of the outside ribs by the bearing seat and an outward biasing of the inside ribs by the bearing, wherein a resistance to deformation of the sleeve body provides a firm fit for the bearing into the bearing seat.

12. The sleeve of claim 11, wherein the outside ribs are uniformly angularly spaced apart on the outside surface and the inside ribs are uniformly angularly spaced apart on the inside surface.

13. The sleeve of claim 12, wherein the inside ribs reside angularly centered between the pairs of the outside ribs.

14. The sleeve of claim 11, wherein outside ribs have a substantially round profile and the inside ribs have a substantially round profile.

15. The sleeve of claim 11, wherein the outside ribs and the inside ribs axially run substantially the length of the bearing sleeve.

16. An electric motor comprising:
an armature having an armature shaft;
a case enclosing the armature;
an endbell at an open end of the case;
a bearing seat in the endbell;
a bearing between the bearing seat and the armature shaft; and
a bearing sleeve between the bearing and the bearing seat, the bearing sleeve comprising:
a deformable cylindrical sleeve body having an outside surface and an inside surface and a sleeve length;
axially running outside ribs angularly spaced apart on the outside surface;
axially running inside ribs angularly spaced apart on the inside surface angularly between pairs of the outside ribs; and
an axial bearing stop attached to the sleeve body to retain the bearing,
wherein the sleeve body is deformed by an inward biasing of the outside ribs by the bearing seat and an outward biasing of the inside ribs by the bearing, wherein a resistance to deformation of the sleeve body provides a firm fit for the bearing into the bearing seat.

17. The motor of claim 16, wherein the outside ribs are uniformly angularly spaced apart on the outside surface and the inside ribs are uniformly angularly spaced apart on the inside surface.

18. The motor of claim 16, wherein the inside ribs reside angularly centered between the pairs of the outside ribs.

19. The motor of claim 16, wherein outside ribs have a substantially round profile and the inside ribs have a substantially round profile.

20. The motor of claim 16, wherein the outside ribs and the inside ribs axially run substantially the length of the bearing sleeve.
